(19) United States
(12) Patent Application Publication
(10) Pub. No.: US 2007/0101273 A1
(43) Pub. Date: May 3, 2007

(54) System and method for viewing and screening of chemical data from different sources

(76) Inventors: Linda X. Lin, Fremont, CA (US); Gregory P. Houtz, San Jose, CA (US); Tony Brand, (US); Doug McIntyre, Redwood City, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/260,992

(22) Filed: Oct. 27, 2005

(51) Int. Cl. G06F 17/00

(52) U.S. Cl. 715/738; 715/781

(57) ABSTRACT

In a system and method for viewing and screening data from multiple analysis instruments in a single display, a display device coupled to a processor, displays a universal browser window. The browser window includes a first portion and a second portion. A memory also coupled to the processor, has stored therein a software program including instructions for execution by the processor. The software program includes instructions for saving a first set of data relating to a first batch of sample(s) from a first analysis instrument in a first format, saving a second set of data relating to the first sample from a second analysis instrument in the first format, combining the first set of data and the second set of data into a first file, storing the first file in the memory, displaying the first set of data in the first portion of the universal browser window, and displaying the second set of data in the second portion of the universal browser window in conjunction with the display of the first set of data in the first portion of the browser window.

### BACKGROUND OF THE INVENTION

In the field of analytical chemistry, which is a key functional part of most pharmaceutical and biotechnology companies, research institutes and environmental analysis labs, to mention just a few, various types of equipment and instruments, available from various vendors, are used for various processes, such as, for example, compound separation, purification, qualification and quantification, among other things. More and more often, companies and labs require more that one type of instrument, which often come from multiple vendors.

There are various issues that arise as a result of using multiple pieces of equipment from multiple vendors, including different formats for the input, output and presentation of data, different operating instructions and protocols for the different vendors and different compatibility. Several significant problems are manifest from high throughput compound screening and analysis.

One problem is the difficulty for chemists and bio-chemists to quickly screen a large batch of samples that are run through one or more systems and to obtain a quick overview or summary of key results of the batch of samples. Often they need to analyze the data sample by sample, comparing the results of the various samples, back and forth, which is very time consuming and inefficient.

One system and method that has been used in an attempt to deal with this problem is the Agilent ChemStation data browser software run with Agilent 1100 LC and LC/MS (single quad) instrument. A software application in the Agilent 1100 LC and LC/MS, incorporated herein by reference, has attempted to solve this problem by providing a single intermediate data file generation, coupled with a viewing software with a file tree explorer utility, a plate view utility and summary CSV report for the whole batch of samples. Despite these attempts, this product has been unable to solve the problems identified above. For example, it only supports data from ChemStation software and does not work for other products or product lines, including for products such as other Agilent LC/MS types of instruments (ion-trap, Time-Of-Flight), Agilent GC and GC/MS, and; and it can only view data transferred from the intermediate AEV file in the current system.

Another problem with current technology solutions is that it is currently impossible to use only one software product to sufficiently view data generated by different types or brands of equipment and instruments and vendors. Different vendors and, in many cases, different products manufactured by the same vendor have different data storage formats and protocols and use different formats and protocols and software programs for data analysis and reporting. This requires that users be familiar with a variety of protocols, commands, system structures, GUIs, data presentations and reports, among other things.

For the most part, users are primarily interested in two major categories of information: general information and compound/application/instrument specific information. While the current systems that are available are able to provide these categories of information regarding their own systems, they are not able to provide similar information for competitors' systems and to a large degree other products made by the same company.

### SUMMARY OF THE INVENTION

The present invention solves the above problems by providing a system and method for data viewing, browsing and screening that can be used by users of a variety of different types of equipment and chemical instruments from the same or different vendors to quickly and easily view information, obtain an overview and report regarding a set of runs, examine both general and specific information at both a top level overview and a more detailed level of review, and allow companies and laboratories to build a centralized data storage and control system to house and allow access to and review of data from different sources.

The present invention provides a method for viewing and displaying data from multiple analysis instruments in a single display, comprising saving a first set of data relating to a first batch of sample(s) from a first analysis instrument in a first format, saving a second set of data relating to the first batch of sample(s) from a second analysis instrument in the first format, combining the first set of data and the second set of data into a first file, storing the first file in a first location, displaying the first set of data in a first portion of a browser window, and displaying the second set of data in a second portion of the browser window in conjunction with the display of the first set of data in the first portion of the browser window.

The present invention provides a system for viewing and displaying data from multiple analysis instruments in a single display, comprising a processor, a display device coupled to the processor, the display device displaying a browser window, the browser window including a first portion and a second portion, and a memory coupled to the processor, wherein the memory has stored therein a software program including instructions for execution by the processor for saving a first set of data relating to a first batch of sample(s) from a first analysis instrument in a first format, saving a second set of data relating to the first batch of sample(s) from a second analysis instrument in the first format, combining the first set of data and the second set of data into a first file, storing the first file in the memory, displaying the first set of data in the first portion of the browser window, and displaying the second set of data in the second portion of the browser window in conjunction with the display of the first set of data in the first portion of the browser window.

The present invention provides a computer program product for use with a system for viewing and displaying data from multiple analysis instruments in a single display, comprising a computer usable medium having computer readable program code embodied therein for controlling viewing and displaying of data, the computer readable program code including computer readable program code for saving a first set of data relating to a first sample from a first analysis instrument in a first format, computer readable program code for saving a second set of data relating to the first batch of sample(s)_ from a second analysis instrument in the first format, computer readable program code for combining the first set of data and the second set of data into a first file, computer readable program code for storing the first file in the memory, computer readable program code for displaying the first set of data in the first portion of the browser window, and computer readable program code for displaying the second set of data in the second portion of the browser window in conjunction with the display of the first set of data in the first portion of the browser window.

The present invention provides for the improved regulation and centralization of data and comparison of data, thereby reducing equipment and support costs, the difficulty of data analysis and diagnosis, and amount of display equipment.

The present invention provides for the amalgamation, reading and displaying of both general information and compound, application, and instrument specific information having various data formats and derived from various software applications embedded within a variety of vendor equipment and instrumentation into a single viewing format having a consistent look and feel and uniform usage parameters. The present invention also directly provides or provides a link to useful publicly available and customizable special data analysis and examination utilities, and generates summary and individual reports as required by the user in a consistent format.

The system and method according to an embodiment of the present invention takes the data output from data analysis software for various types and brands of equipment and instruments and reformats the data output and converts it to an intermediate file format that may be utilized as a universal language or format for such data. For example, this intermediate file format may be an ASCII file or some other type of file format. The file is formatted based on particular identifiers that are embedded within the file structure.

The present invention provides a system and method for interfacing and an interface apparatus that can be used to view the output data from the data analysis software and/or equipment and instruments. The present invention provides a browser that can parse, format, present, manage, organize, modify, display and search the data that has been output by the data analysis software and/or that has been reformatted by the system. The browser includes a graphical user interface (GUI) that is usable for all types of data from all types of equipment and instruments, provided that the data has been converted from the intermediate file format into, or is provided directly in the universal language or format, such as, for example, AEV, RPT or some other compatible file format. The reformatting of data from systems using a different file format or language may include, for example, parsing the data, identifying the different categories of information included in the data stream, identifying the type of equipment from which the data is being transferred, identifying the data structure of the data stream, and converting the format and coding of the data into a universal intermediate file format for presentation or display by the browser in a window, screen presentation or on a display device.

The present invention can provide or present the data for reproduction by some other means, such as, for example, printing or exporting into other applications in a universal format. The system and method provides a report printing capability for samples run from various kinds of instruments, in a robust and universal report format. It allows user to select when to print the browser report for desired sample(s) in a user desired format. The report printing can be either completely done automatically after each sample run or each batch of sample(s), or done manually by user from data browser. The universal browser software can also export reports such as the summary report of the whole file or plate, plate view report, individual sample report and fraction list report.

The raw data that is reformatted and included in a universal language or format, such as, for example, AEV, RPT, XML, or some other file format, includes the following information:

1. System configuration and sample header information, such as, for example, plate/tray type, temperature, solvent and ratio, flow rate, wavelength for UV detectors, mass spectrometer condition setup, sample name, sample type, operator name, instrument name, date and time the sample was run, sample location, raw data file name and location, target mass input for the sample, which method was run to acquire the data and which was run to do the data analysis, how much sample volume was injected, and injection number.

2. Target information, such as, for example, target mass/formula/name.

3. Fraction collection information, such as, for example, where the fraction was collected, how much volume was collected, what triggered the fraction collection, and the mass that was collected.

4. Chromatogram data, such as, for example, X(retention time) and Y(% Intensity) data for the whole chromatogram signal, a list of chromatographic peaks, such as, for example, peak #, retention time, start and end time, area, height, % area, peak width, base peak mass, and peak purity results.

5. Spectrum data, such as, for example, mass spectrum or UV spectrum data for chromatographic peaks, mass found in the mass spectrum, and data type (profile or centroided).

6. Sample purity calculation results, such as, for example, which type of calculation was used, how pure is the target if it's found in the sample according to the selected type(s) of calculation, and in which peak the target was found.

As described above, the system includes two components, a browser, and an intermediate file generator (for example, an AEV file generator). The browser is a stand alone component which includes browsing, reporting, viewing, data manipulation, importing and exporting capabilities, among other things. The intermediate file generator is used in conjunction with or coupled to a data analysis component to generate an AEV file from the output of the data analysis component. The data analysis component is generally coupled to the output of one or more pieces of equipment or instruments. However, the data analysis component can be a standalone piece of equipment that is fed data obtained from one or more pieces of equipment or instruments. The intermediate file generator can also be used with files in other formats, such as, for example, an RPT file or a WIFF file, and it can be used to convert a different file format, such as, for example, an RPT file or a WIFF file, to the universal intermediate file, such as an AEV file format.

For example, an RPT file does not include all of the information that is allowed to exist in an AEV file. Thus, any AEV file generated based on an RPT file can have empty data fields for those supported but not available information. On the other hand, a WIFF file which stores all raw data and lots of other information might have a lot more data and information than what the user needs to know. The AEV file generated based on the WIFF file contains only those information the user needs to know, which significantly reduce the size of data storage. The type of file and software from which the data that is to be converted is derived, in most cases, will be identifiable by the system based on the coding found in the output data stream from the equipment or instrument, based on the software language used and/or based on the structure of the data.

According to one embodiment of the present invention, for example, when the system is hooked up to a LC/MS system, a sample may be run through the LC/MS system and raw data will be output. The system includes data acquisition software that will generate the output of the LC/MS instrument. The raw data output of the LC/MS does not have any integration results or peaks as it has not yet been run through a data analysis component. The data analysis component or application includes software that provides for processing of the raw data and performing integration on the raw data. For example, one type of data analysis software application is included in the ChemStation software product. The output of the data analysis component and/or application may be a binary file having a particular format. Each type of data analysis component or application manipulates the data into one or more specific data formats. The data analysis component of the present invention includes an AEV file format generator. The AEV file format generator includes a data formatting tool that converts the raw data into an AEV file format that can be used by the data browser software and/or application and other parts of the system for storage, viewing and comparison of the results.

The data browser software and/or application provides certain capabilities, such as, for example, exporting data files and reports for display, visual reproduction, data summarizing, including printed copies, or for exporting to a spread sheet, or copying and pasting to a clipboard or other software application.

The system according to the present invention is robust and expandable in that it allows users to plug in additional components, such as, for example, components that can read and recognize specific types of information and data formats. For example, the system can integrate equipment and instruments that read and recognize data reports from small molecule compound analysis, using HPLC, LC/MS(single quadropole), LC/MS(Time-of-flight), LC/MS(ion-Trap) or other types of instruments, empirical formula confirmation report, analysis, empirical formula generation reports, and/or compound confirmation screening reports, to name just a few. It can also read and recognize data reports from protein deconvolution/identification analysis, metabolite identification analysis and peptide identification analysis, when these data analysis software link with the AEV file or intermediate file generator. The system according to the present invention also includes and allows for the plug in or add on of components that provide for the display of specific information in specific formats. The system also provides open interfaces to allow for the communication with external processes, and linking to external utilities that are necessary or useful for specific laboratories, equipment, samples and/or applications.

The source code for these open interfaces may be either derived from open source code or custom designed and can be easily modified to allow for creation of equipment and instrument specific or compatible interfaces, provided that the system user interfaces, including for the browser portion, maintain compatibility with the current system components.

The system according to the present invention provides a consistent look and feel to allow users to become familiar, confident and adept in use of the system. The GUIs are also consistent across various levels and interfaces to provide a familiar and easily learnable and transferable solution. For example, the GUIs for displaying group, batch and sample level information are very similar and have many common features. Additionally, the interfaces and GUIs include multi-levels of data and can be parsed through to provide expanded amounts of data and scope of detail regarding the features or outputs being reviewed.

The browser component and/or application includes the capability of parsing the data and moving through multiple levels of information for expanding specific details relating to portions of the information provided in the viewing window. This additional information can be displayed in a new, additional or the same window of the browser or in another browser window.

The present invention can also provide new ways of automated data report to chemists or biologists, utilizing and expanding the new and scalable capability of linking internal data viewing and reporting activities with external processes or applications.

For example, when a user is viewing the data from the data browser software, and a specific piece of information pre-defined by the user is found in the data, data browser can pass that specific information to a pre-known external process or application for special further action. This system and method can also be extended to provide an automatic report emailing in a way the user setup for certain conditions. For example, after a batch of sample(s) is run, the data browser automatically screens the data of the batch; when certain conditions or criteria is met, data browser sends an email with or without a report in a pre-defined format to the pre-setup email account. Thus data analysis and report can be highly automated and the whole productivity can be significantly improved.

### BRIEF DESCRIPTION OF THE DRAWINGS

FIG. 1 shows a system level drawing of the viewing and screening system according to an embodiment of the present invention.

FIG. 2 shows a flow diagram of a process according to an embodiment of the present invention.

FIG. 3 shows a screen shot of a plate view selection GUI according to an embodiment of the present invention.

FIG. 4 shows a screen shot of a browser GUI according to a first embodiment of the present invention.

FIG. 5 shows a screen shot of a browser GUI according to a second embodiment of the present invention.

FIG. 6 shows a screen shot of a browser GUI displaying data in multiple windows according to an embodiment of the present invention.

### DETAILED DESCRIPTION

The term browser refers to a software program that can access and display files and other data available on a network, such as, for example, a local area network (LAN), wide area network (WAN), the Internet, or some other network. A browser can display graphics as well as text, and can present multimedia information, including sound and video. A browser can also reformat data.

The term browser window refers to an enclosed area on a display screen that is used to display information accessed by the browser. The browser window can be formatted in any shape or size.

The term analysis instrument refers to an instrument for analyzing the composition, structure, or other attributes, elements, properties or features of a sample.

The term sample refers to a compound or portion of a compound.

The term sample plate refers to a physical structure that includes one or more portions, in the form of an array or matrix when more than one portion is included, for the positioning of samples, including, but not limited to, one or more recessed portions for the direct positioning of samples or one or more framed portions for positioning of containers that include samples.

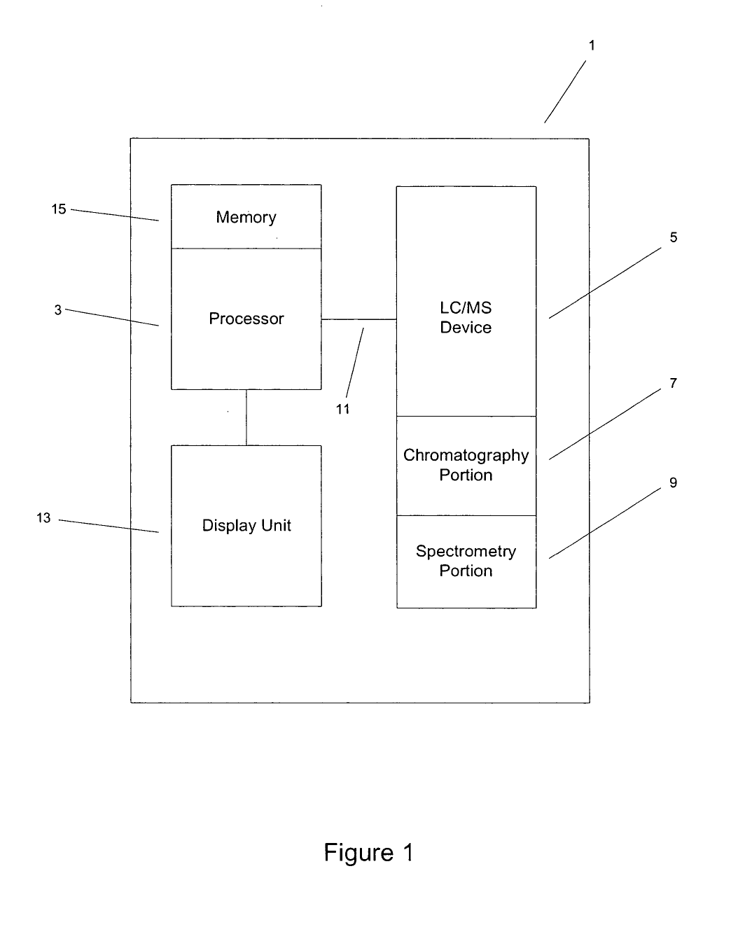

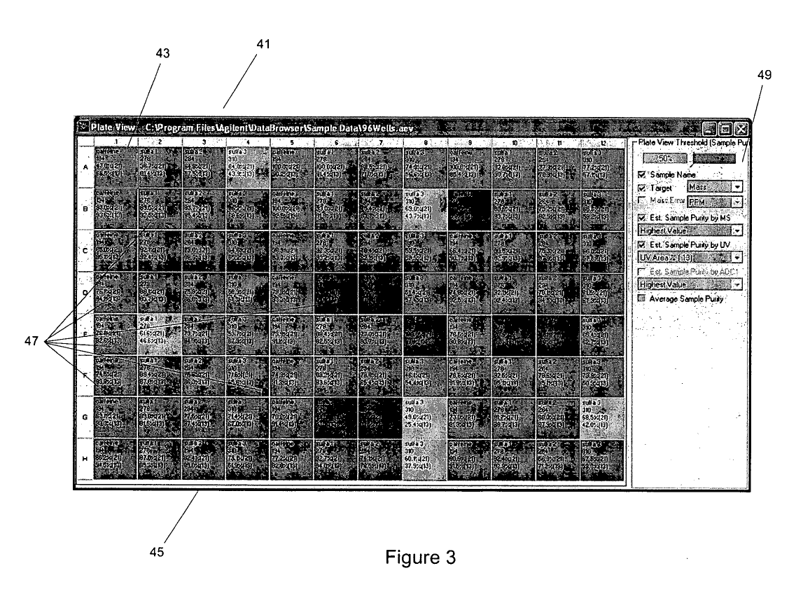

As shown in FIG. 1, there is provided a system level drawing of the viewing and screening system according to an embodiment of the present invention. The viewing and screening system 1 includes a processor 3 coupled to a LC/MS device 5 having an output from the chromatography portion 7 and an output from the spectrometry portion 9. The LC/MS device is coupled to the processor via cable 11. The processor is coupled to a display unit 13 for displaying processed information relating to sample analysis. The processor 3 runs a software application stored in a memory 15 coupled to the processor 3. The software application controls a graphical user interface (GUI) that is used to display the processed information relating to sample analysis. The GUI is further described by reference to FIG. 3. The software application also includes a browser program that displays information on the display unit 13 through one or more browser windows.

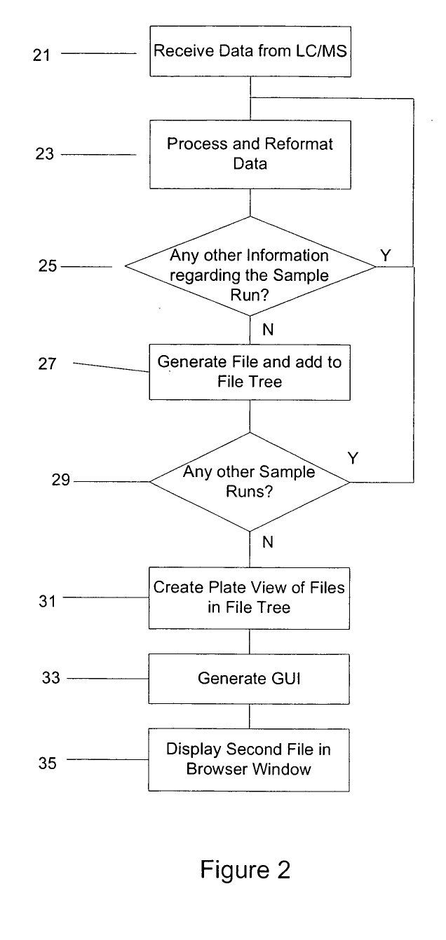

In FIG. 2 there is shown a flow diagram of a process according to an embodiment of the present invention. In step 21, the system receives information in raw data format (or in a pre-processed format) from the LC/MS device 5 relating to a sample run. In step 23, the processor 3 processes the information and reformats the information from the raw data format into an intermediate file format. The reformatting of the information includes, for example, parsing the information, identifying the different categories of information that are included, identifying the type of equipment from which the information is being transferred, identifying the structure of the information as transferred in the raw data format, and converting the format and coding of the raw data format into a universal intermediate file format for display in a system browser window or on a display device. The formatting of the information for the intermediate file format will be further discussed below.

The type of file and software from which the information is derived is identifiable based on the coding found in the raw data format, based on the software language used and based on the structure of the information as provided in raw data format. In step 25, the system queries whether any other information is being received by the system relating to the sample run. If additional information is being received, the system continues to process the information. If no additional information is detected for the sample run, in step 27 the processor 3 generates a file corresponding to the sample run, in intermediate file format, and adds that file to a file tree. In step 29, the system queries whether information is being received relating to another sample run. If information is being received, the system returns to step 23. If no further information is being received, in step 31 the system creates a plate view of the files in the file tree.

A plate view selection GUI, as shown in FIG. 3, is an application for displaying the results of an analysis of a sample plate by one or more pieces of equipment or instruments. A sample plate is physical structure designed, as an array or two-dimensional matrix, to hold a number of samples. This matrix or array can be structured as a rectangular plate that includes a plurality of recessed portions, for example, in an 8×12 array. Alternatively, it can be structured as a frame including a matrix or array of openings for positioning sample holders or test tubes. The plate or frame may be any shape. The plate is processed by one or more pieces of equipment or instruments and the results are mapped or presented in a plate view selection GUI 41, as a visual display of the results of the processing, in locations corresponding to the location of the sample in the matrix or array. Thus, the sample located in the first column and third row of the plate will be displayed in the plate view selection GUI 41 in the (1, 1) location 43 corresponding to the first column and the first row. The plate view selection GUI will be discussed further below.

In step 33, the system generates a GUI that allows a user to select a file and display various information relating to the file in a system browser window, including information generated by different types and brands of equipment and/or instruments. In Step 35, if the user chooses a second file, the second file may be displayed in a second browser window or a portion or portions of the second file may be displayed in a portion or portions of the first browser window.

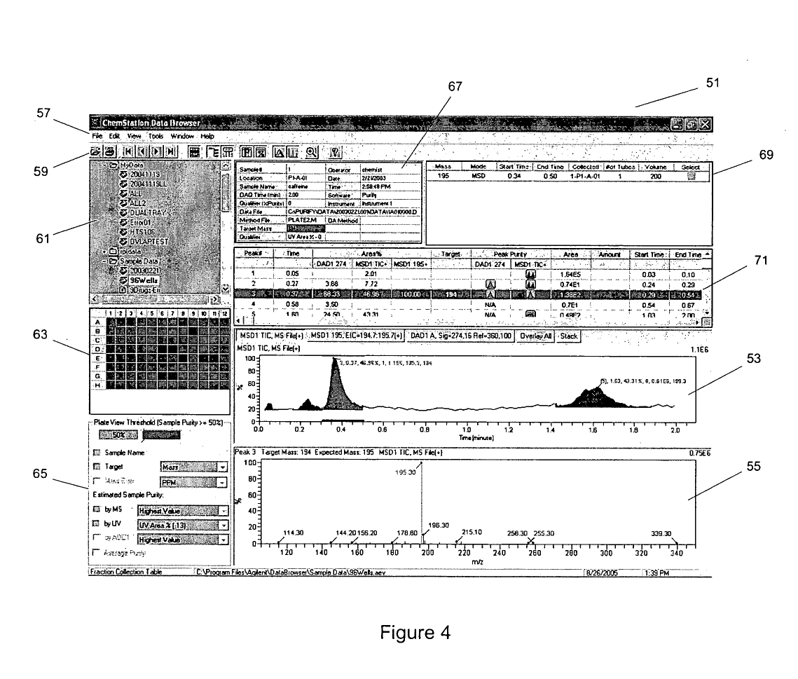

Looking now at FIG. 4, there is shown a screen shot of a browser GUI according to an embodiment of the present invention. This screen shot of the browser GUI 51 shows how a conglomeration of information from a variety of sources, for example, equipment or instruments is presented by the system for viewing. As shown in the screen shot, the sources include, for example, such equipment as chromatography systems and mass spectrometry systems. The data presented in the browser GUI 51 corresponds to the data resulting from a sample being run through a LC/MS system. The information shown in the chromatography data display 53 represents the results of a first batch of sample(s) from the sample plate run through the chromatography portion 7 of the LC/MS device 5. The information shown in the mass spectrometry data display 55 represents the results of the first sample from the sample plate run through the mass spectrometry portion 9 of the LC/MS device 5.

The browser GUI 51 includes a function menu 57 as well as a viewing/browsing utility bar 59 that includes a number of buttons providing various functionality. This functionality includes, for example, file open, print report, sample navigation (go to first sample, previous sample, next sample, last sample), sample plate navigation (go to previous plate, next plate, plate 1, plate 2, vial tray), turn on/off individual display objects (file tree, plate view in main window or a separate window, sample header table, peak table, chromatogram panel, spectrum panel, EFC table, EFG table, Compound confirmation screening table), launch online help. Additional buttons may be added, for example, to provide links to other software applications in order to provide for the plug in of specific information displays or specific data analysis. The browser also includes a file tree 61 which identifies the files accessible by the system for display or viewing. This file tree 61 identifies the files containing information available for display by the browser. The files contain information relating to one or more samples, and can include, for example, information relating to an automatic batch run of multiple samples, such as, for example, from a sample plate. The data in each file is stored in compartmental structure with specific information located in particular locations of the file and in particular sequences. These locations and sequences can vary according to system preference. The system takes the data output from the data analysis software for various types and brands of equipment and instruments and reformats the data output and converts it to an AEV intermediate file format, which is an ASCII type file, based on particular identifiers. The interface method as provided by the browser and the GUI is usable for all types of data from all types of equipment and instruments, provided that the data is converted to the AEV, RPT or some other compatible file format, which can be accomplished by the system using the file formatting component or application.

A plate view selection screen 63 is provided by the browser GUI 51 which allows the user to toggle between the results for the different samples included in the sample plate such that the results for different samples may be viewed one after the other for simplified comparison of the results. In this example, the sample plate comprises an 8×12 matrix. Alternatively, the results for the different samples or the outputs for the same or multiple samples from different pieces of equipment or instruments may be displayed in separate browser windows or as separate views or portions of a single browser window. The plate view selection screen 63 includes color coding to identify the quality of the results from each of the sample runs. A plate view display options selection screen 65 is also provided in the browser GUI 51. This screen provides for the customization of data viewing by user or automatic modification of the parameters for viewing or display of the samples based on preference or certain predetermined or user defined criteria. The parameters that may be modified in this example include: Plate View Threshold, where the sample purity level is set at greater than or equal to 5050%; Sample Name; Target, including Mass; Mass error, in parts per million (PPM); Estimated Sample Purity, by MS (setting the Highest Value), by UV (setting UV Area %), by ADC 1 (setting Highest Value), and Average Purity.

The sample information display 67 shows information about one or more samples being viewed in the browser GUI 51. The sample information display 67 may include information such as, for example, sample number, operator information, location of the sample, date of processing, sample name, time of processing, DAQ time, software used, any qualifiers, such as, for example, purity level and UV area %, instrument used for the processing, the location and name of the data file, method file, DA method, and target mass.

For each sample there is also provided, when available, a fraction collection table display 69 and a peak table display 71. The information provided in the fraction collection table display 69 may include information, such as, for example, mass, mode, start time, end time, collected (this may be the same information as location), number of tubes, volume and may include a button to select the display item. The peak table display may include information of the integrated chromatographic peaks found in the sample, such as, for example, peak number, retention time, area %, target mass found in the peak, base peak mass found in the peak, peak purity value (including MS peak purity and/or UV peak purity), absolute peak area, peak width, peak height, amount/concentration of compound detected in the peak, start time, end time, detector used to acquired the peak, description of the chromatogram in which the peak is found, to name only a few. User can select what information to be shown in the peak table.

In this example, sample 1 from the file 96Wells.aev is being displayed in the browser GUI 51. The third peak has been selected in the peak table display 71 as noted by the highlighting of the row identified as 3 in the Peak# column. The fraction collection table display 69 shows certain information relating to Peak# 3.

The chromatography data display 53 shows a timeline of the run of Sample# 1 through the chromatography portion of the LC/MS device 5. The mass spectrometry data display 55 shows the m/z distribution of Sample# 1 for the run through the spectrometry portion of the LC/MS device 5.

Each of the portions of the screen display from the browser GUI 51 in FIG. 4 may be expanded for display in a separate portion of the browser GUI 51 or in a separate browser widow for viewing of additional levels of detail. This can be accomplished by clicking on the corresponding button on the utility bar or by clicking on the relevant portion of the display.

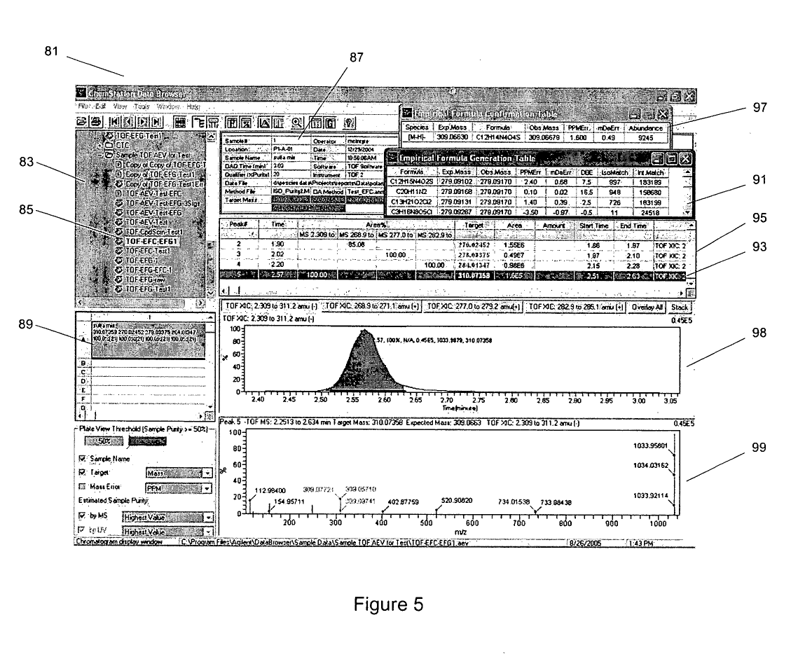

In FIG. 5, there is shown another example of a browser GUI displaying sample data. The browser GUI 81 includes a file tree 83 which shows a highlighted file 85, named TOF-EFC-EFG1. The highlighted file 85 relates to a test of a sample identified as Sample# 1. Information regarding Sample# 1 is presented in the sample information display 87. Specific information relating to Sample# 1 is also displayed in the plate view selection screen 89 as item A1 in the matrix. Here the plate view selection screen 89 is displayed in the browser GUI 81 in an enlarged view. The empirical formula generation table 91 shows a number of possible matches as to the identity of the highlighted component 93 from peak 5 of Sample# 1 that is shown in the peak table display 95. The empirical formula generation table 91 includes information, such as, for example, formula, expected mass, observed mass, mass error in PPM, mass error in mDa, DBE (double bond equivalent), Isotope Match score, and Intensity Match score. The empirical formula confirmation table 97 shows information about the compound falling closest to the highlighted component 93 from the peak table display 95, including species, expected mass, formula, observed mass, mass error in PPM, mass error in mDa, and abundance. The empirical formula generation table 91 and the empirical formula confirmation table 97 are presented by the system in separate browser windows.

The chromatography data display 98 shows a timeline of the run of Sample# 1 through the chromatography portion of the LC/MS device 5. The mass spectrometry data display 99 shows the m/z distribution of Sample# 1 for the run through the spectrometry portion of the LC/MS device 5.

Looking again at FIG. 3, the plate view selection screen 63, as shown in FIG. 2, may be expanded into the plate view selection GUI 41 by clicking on the utility button or by clicking on the plate view selection screen 63. The expanded plate view selection GUI 41 includes a plate view summary section 45 that includes a number of sample data boxes 47, each representing a different plate (or sample) that was processed by the LC/MS system, and each providing a summary of information about the plate or sample. By clicking on each of the sample data boxes 47 a user can then open a separate display screen for viewing the specific data for the plate or sample represented by the corresponding sample data box 47. The expanded plate view selection GUI 41 also includes a portion that provides a plate view display options selection screen 49. The plate view display options selection screen 49 is used to modify the parameters for display of the plate view data, including the information that is displayed in each of the sample data boxes 47. The sample data boxes are color coded to provide a quick visual cue as to the nature of the results relating to the sample that was analyzed. For example, a green colored sample data box indicates that the sample run resulted in a usable or positive result. A red colored sample data box indicates that the sample run resulted in an error or failure, such as, for example, a tainted or poor quality sample. A yellow colored sample data box indicates that the result of the sample run resulted in an inconclusive result.

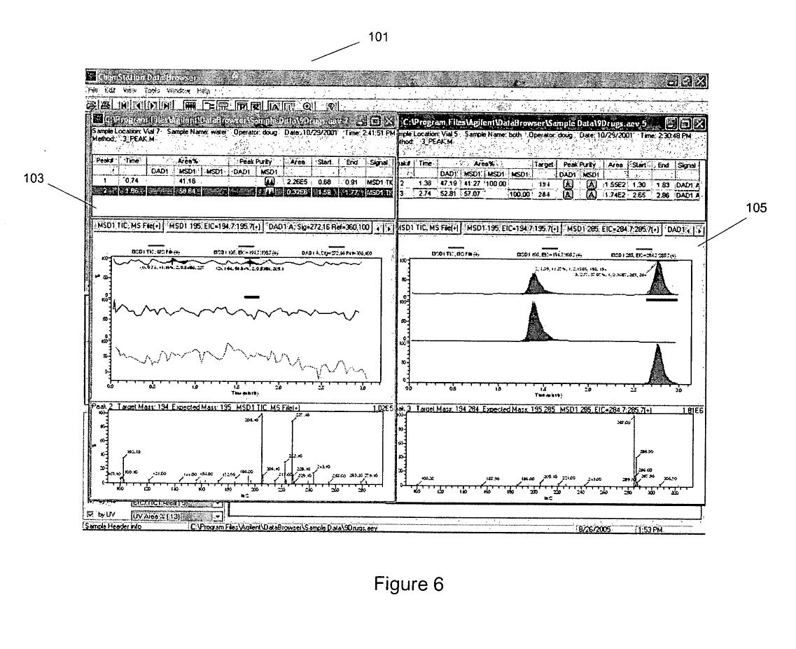

Looking now at FIG. 6, there is shown another example of a browser GUI displaying data in multiple windows. The first browser GUI 101 is overlapped by a second browser GUI 103 and a third browser GUI 105. The second browser GUI 105 shows the results from an analysis of a sample having the following identifying information:
Sample Location: Vial 7
Sample Name: water
Operator: doug
Date: Oct. 29,2001
Time: 2:41:51 PM
Method: 3_PEAK.M

The second browser GUI 103 is presented in an area comprising approximately half of the first browser GUI 101 window which is a fully expanded browser window. The third browser GUI 105 is presented in an area comprising approximately the other half of the first browser GUI 101 window. The third browser GUI 105 shows the results from an analysis of a sample having the following identifying information:
Sample Location: Vial 5
Sample Name: both
Operator: doug
Date: Oct. 29,2001
Time: 2:30:48 PM
Method: 3_PEAK.M

In FIG. 6, the data that resulted from the sample run of Vial 5 may be displayed side by side with the data that resulted from the sample run of Vial 7, thereby allowing a direct and visual comparison of results on a display device potentially in near real time. This visual display on a display device also provides the user with the capability of manipulating the data or viewing other data relating to the different sample runs for a fuller analysis and comparison of the data with interactive capabilities. For example, a user may expand or shrink portions of the data being displayed, view different pieces or sections of information and/or compare various pieces of information. This saves the user time and effort in not having to print the results from different runs and only compare hard copies of the results.

What is claimed is:

1. A method for viewing and displaying data from multiple analysis instruments in a single display, comprising:
saving a first set of data relating to a first sample from a first analysis instrument in a first format;
saving a second set of data relating to the first sample from a second analysis instrument in the first format;
combining the first set of data and the second set of data into a first file;
storing the first file in a first location;
displaying the first set of data in a first portion of a browser window;
displaying the second set of data in a second portion of the browser window in conjunction with the display of the first set of data in the first portion of the browser window.

2. The method according to claim 1, further comprising:
saving a third set of data relating to a second sample from a third analysis instrument in a first format;
saving a fourth set of data relating to the second sample from a fourth analysis instrument in the first format;
combining the third set of data and the fourth set of data into a second file;
storing the second file in a second location;
displaying the third set of data in a third portion of the browser window; and
displaying the fourth set of data in a fourth portion of the browser window.

3. The method according to claim 2, wherein the first analysis instrument and the third analysis instrument are the same instrument, and wherein the second analysis instrument and the fourth analysis instrument are the same instrument.

4. The method according to claim 2, wherein the first portion of the browser window is the same as the third portion of the browser window, and wherein the second portion of the browser window is the same as the fourth portion of the browser window.

5. The method according to claim 1, further comprising converting the first set of data relating to a first sample from a first analysis instrument to the first format and converting the second set of data relating to the first sample from a second analysis instrument to the first format.

6. The method according to claim 1, wherein the first portion of the browser window is adjacent to the second portion of the browser window.

7. The method according to claim 2, further comprising displaying the fourth set of data in a fourth portion of the browser window in conjunction with the display of the third set of data in the third portion of the browser window.

8. The method according to claim 7, wherein the third portion of the browser window is adjacent to the fourth portion of the browser window.

9. The method according to claim 2, further comprising displaying the first set of data in a first portion of the browser window in conjunction with the display of the third set of data in the third portion of the browser window.

10. The method according to claim 2, wherein the third portion of the browser window and fourth portion of the browser window are parts of a second browser window.

11. A system for viewing and displaying data from multiple analysis instruments in a single display, comprising:
a processor;
a display device coupled to the processor, the display device displaying a browser window, the browser window including a first portion and a second portion; and
a memory coupled to the processor, wherein the memory has stored therein a software program including instructions for execution by the processor for:
saving a first set of data relating to a first sample from a first analysis instrument in a first format,
saving a second set of data relating to the first sample from a second analysis instrument in the first format,
combining the first set of data and the second set of data into a first file,
storing the first file in the memory,
displaying the first set of data in the first portion of the browser window, and
displaying the second set of data in the second portion of the browser window in conjunction with the display of the first set of data in the first portion of the browser window.

12. The system according to claim 11, wherein the software program includes additional instruction for execution by the processor for:
saving a third set of data relating to a second sample from a third analysis instrument in a first format,
saving a fourth set of data relating to the second sample from a fourth analysis instrument in the first format,
combining the third set of data and the fourth set of data into a second file,
storing the second file in the memory,
displaying the third set of data in a third portion of the browser window, and
displaying the fourth set of data in a fourth portion of the browser window.

13. The system according to claim 12, wherein the first analysis instrument and the third analysis instrument are the same instrument, and wherein the second analysis instrument and the fourth analysis instrument are the same instrument.

14. The system according to claim 12, wherein the first portion of the browser window is the same as the third portion of the browser window, and wherein the second portion of the browser window is the same as the fourth portion of the browser window.

15. The system according to claim 11, further comprising converting the first set of data relating to a first sample from a first analysis instrument to the first format and converting the second set of data relating to the first sample from a second analysis instrument to the first format.

16. The system according to claim 11, wherein the first portion of the browser window is adjacent to the second portion of the browser window.

17. The system according to claim 12, further comprising displaying the fourth set of data in a fourth portion of the browser window in conjunction with the display of the third set of data in the third portion of the browser window.

18. The system according to claim 17, wherein the third portion of the browser window is adjacent to the fourth portion of the browser window.

19. The system according to claim 12, further comprising displaying the first set of data in a first portion of the browser window in conjunction with the display of the third set of data in the third portion of the browser window.

20. The system according to claim 12, wherein the third portion of the browser window and fourth portion of the browser window are parts of a second browser window.

21. A computer program product for use with a system for viewing and displaying data from multiple analysis instruments in a single display, comprising:
a computer usable medium having computer readable program code embodied therein for controlling viewing and displaying of data, the computer readable program code including:
computer readable program code for saving a first set of data relating to a first sample from a first analysis instrument in a first format,
computer readable program code for saving a second set of data relating to the first sample from a second analysis instrument in the first format,
computer readable program code for combining the first set of data and the second set of data into a first file,
computer readable program code for storing the first file in the memory,
computer readable program code for displaying the first set of data in the first portion of the browser window, and
computer readable program code for displaying the second set of data in the second portion of the browser window in conjunction with the display of the first set of data in the first portion of the browser window.
